(19) United States
(12) Patent Application Publication
(10) Pub. No.: US 2014/0164083 A1
(43) Pub. Date: Jun. 12, 2014

(54) FINANCIAL PAYMENT SYSTEMS LINKED TO CUSTOMER ACCOUNTS

(71) Applicant: GALILEO PROCESSING, INC., Salt Lake City, UT (US)

(72) Inventor: T. Clay WILKES, North Salt Lake, UT (US)

(21) Appl. No.: 13/945,869

(22) Filed: Jul. 18, 2013

Related U.S. Application Data
(60) Provisional application No. 61/673,117, filed on Jul. 18, 2012.

(51) Int. Cl. G06Q 30/02; G06Q 20/08

(52) U.S. Cl. CPC G06Q 30/0215; G06Q 20/08
USPC 705/14.17; 705/44

(57) ABSTRACT

A computer-implemented method and system for linking a financial payment system to a customer account. A customer account may be created that includes an identifier for a financial payment system, such as a credit or debit card. During a transaction between the customer and a merchant, the identifier may be received by a payment processor. The processor correlated the identifier with a customer using stored customer account information. An electronic message including an incentive offered by the merchant is generated and sent to the customer. The offer may include a condition that the customer must complete in order to receive the incentive. The condition may be, for example, a requirement that the customer provide predetermined information to the merchant or as a posting on a social network. The incentive may be provided to the customer as a refund directly applied to the financial payment system.

### CROSS-REFERENCE TO RELATED APPLICATIONS

This application claims priority to and the benefit of U.S. Provisional Application No. 61/673,117, filed Jul. 18, 2012, titled FINANCIAL PAYMENT SYSTEMS LINKED TO CUSTOMER ACCOUNTS, which is incorporated herein by reference in its entirety.

### TECHNICAL FIELD

Embodiments of the invention relate generally to financial payment systems and their use in conjunction with mobile devices and social networks. More particularly, the invention relates to methods and systems for linking a particular financial payment system, such as a credit card, to a particular customer via a mobile device and to providing incentives to customers using the financial payment system to facilitate customer feedback using at least one social network.

### BACKGROUND

When making a purchase from a merchant, a customer generally uses cash, a credit card or a check as a form of payment. While point of sale systems (POS systems) used by merchants are designed to track information related to the sale, such as the products, prices, dates and stock-keeping unit (SKU) information, such systems do not provide the merchant with information about the customer. If the customer uses a credit card to make the purchase, the merchant may capture the customer's credit card information along with information about the customer's purchase. The merchant will often ask the customer for identifying information, such as a zip code, phone number or email address, in order to link the customer with their credit card information.

Merchants have made efforts to track customer information by offering incentive programs in exchange for customer registration. One example of this type of incentive program is a customer loyalty or reward system that provides rebates or discounts to registered customers. Such reward systems enable merchants to gather information about the purchases of particular, registered customers to determine the types of products they buy.

Generally, reward programs may be cost prohibitive, especially for small merchants, due to costs associated with generating, administering and tracking customer participation in the program. Such costs increase dramatically when the merchant uses an outside company to handle the rewards program. Moreover, customers may be hesitant to participate in such reward programs due to the inconvenience of the registration process during checkout or the belief that such programs result in overall price increases.

Merchants have also made an effort to increase sales by using companies that offer coupons or discount vouchers to customers via the Internet on so-called “deal-of-the-day websites.” While these websites are generally effective for encouraging new customers to visit the merchant, they often create problems for both the merchant and customer. As an example, the companies operating the websites take a sizeable share of the offerings further reducing the profit margins. Since the merchant has no direct control over or link to the website, it is not possible for the merchant to obtain any information about the people purchasing its coupons. Customers may perceive coupons or vouchers as an inconvenience to redeem, and may lose or misplace them before getting a chance to redeem them. In addition, by offering the large price cuts required by deal-of-the-day websites, merchants may be attracting the wrong customers as well as diluting their brand. Furthermore, many merchants lack the tools and expertise to analyze the long term value of such programs.

Accordingly, the incentive programs currently available to merchants do not provide an efficient platform for businesses to establish long-term relationships with customers. Furthermore, these programs do not integrate advertising with mobile devices and/or social media networks, the use of which is becoming increasingly more common.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY

One embodiment is directed to a method of linking a financial payment system to a customer account. During a financial transaction between a customer and a merchant, a payment request is received from the merchant and includes a merchant identifier and a customer account identifier for identifying a financial payment system used in the financial transaction. The financial payment system is associated with a registered customer by comparing the customer account identifier with customer account information for the registered customer maintained at the payment processor. An issuer of the financial payment system is contacted to request authorization to grant the payment request.

In another embodiment of a method of linking a financial payment system to a customer account, transaction information relating to a transaction between a merchant and a customer is received using a processor. The transaction information may include, for example, an identifier for a financial payment system used by the customer. The identifier may be correlated with data relating to a customer account stored on a database using the processor to determine if the customer qualifies for an incentive, which can be associated with a purchase for example, provided by the merchant. An electronic message may then be generated by the processor, the electronic message including information related to the incentive. The electronic message may be transmitted to the customer via a software application in communication with the processor and the incentive may be provided to the customer via the financial payment system. Optionally, the electronic message may include a condition for acceptance of the incentive, the condition specifying that the incentive will be provided contingent on the customer accessing at least one social network to broadcast a predetermined message after completion of the transaction between the merchant and the customer. The processor may be used to verify the customer's performance of the condition before the incentive is provided to the customer.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages will be set forth in the description which follows. The features and advantages of the invention may be realized and obtained by means of the instruments and combinations particularly pointed out in the appended claims. These and other features will become more fully apparent from the following description and appended claims.

### BRIEF DESCRIPTION OF THE DRAWINGS

To further clarify the above and other advantages and features of the present invention, a more particular description of the invention will be rendered by reference to example embodiments thereof which are illustrated in the appended drawings. It is appreciated that these drawings depict only example embodiments of the invention and are therefore not to be considered limiting of its scope. The invention will be described and explained with additional specificity and detail through the use of the accompanying drawings in which:

FIG. 1 is a block diagram illustrating an embodiment of a computing system means for linking a financial payment system to a customer account and integrating use of the financial payment system with a mobile device and a social network;

FIG. 2 is a flow diagram illustrating an embodiment of a method of linking a particular financial payment system with a particular customer;

FIG. 3 is a flow diagram illustrating an embodiment of linking a financial payment system to a customer account and integrating use of the financial payment system with a mobile device and a social network; and

FIG. 4 illustrates an example of a processing system means for implementing various aspects of the technology disclosed herein.

### DETAILED DESCRIPTION

The disclosed embodiments enable identification of a customer based on the use a financial payment system. A software application may be provided to the customer for download onto a communications device, such as a mobile phone or tablet device. The customer downloads the software application from a processor and provides pertinent registration information, which may include, name, password, mobile phone number, address, email address, etc. The customer also provides information for a financial payment system, such as a credit or debit card, that will be used by the customer to make purchases. The customer's information is stored in a database accessible by the processor and, upon use of the financial payment system by the customer, may be compared with an identifier of the financial payment system.

The disclosed embodiments also enable merchants to directly and immediately offer incentives to the customer. For example, the customer may present a financial payment system to make a purchase from a merchant. Information about the financial payment system may be transmitted to the processor by the merchant using, for example, a POS system. The processor correlates the payment information with a registered customer and provides the customer with notification of the offer. The offer is presented to the customer on a screen of the communication device through the application downloaded by the customer. The customer may accept or decline the offer, which may include at least one condition that the customer must complete in order to receive the offer. The customer may also accept or decline the offer using the communication device. Using the information provided by the customer upon registration of the application, a refund is provided directly to the customer's financial payment system.

The disclosed embodiments also enable merchants to integrate the customer's purchase or acceptance of the offer with at least one social network. In some embodiments, information about the customer's purchase may be displayed by the social network, such as Facebook® or Twitter®, when the offer is accepted by the customer. In other embodiments, the offer may be provided to a customer contingent on some activity on the social network. Upon verification that the customer has performed the activity, a refund may be provided directly to the financial payment system.

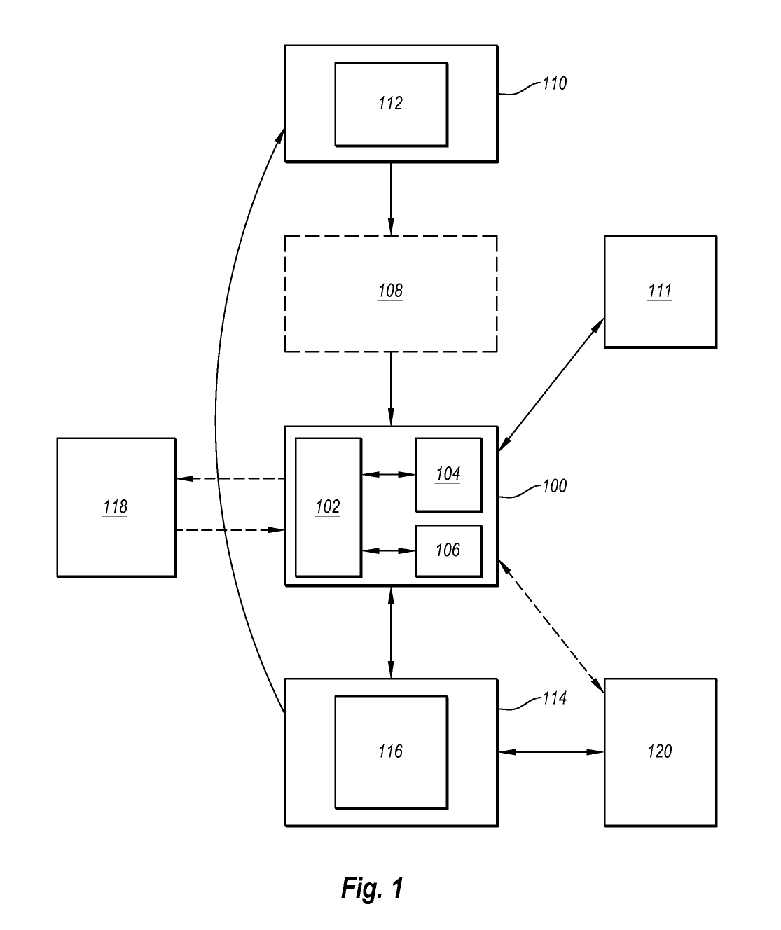

FIG. 1 is a block diagram illustrating an embodiment of a computing system means 100 for correlating a financial payment system with a customer. Financial payment systems include, but are not limited to, credit cards, debit cards, reward cards, near field communication (NFC) and EMV cards. The computing system 100 includes a processor 102, a database 104 and a communications module 106 to enable recognition of the customer and communication between the processor 102 and the customer.

Prior to initiating a transaction at a merchant, the customer completes a registration process during which the customer provides specified information which is received by the processor 102 and is stored on the database 104 to create a customer account. For example, the information provided by the customer to create the customer account may include, but is not limited to, name, address, zip code, age, etc. The customer also provides information related to at least one financial payment system, such as a credit card, debit card, reward card, an NFC tag, etc., which is then linked to the customer account. As will be described in further detail, linking the financial payment system to the customer account enables the transaction between the customer and the merchant to proceed without scanning the actual credit card. For example, the customer may be assigned an account identifier associated with the customer account that may be used to make purchases.

As shown in FIG. 1, the customer may make a selection of items (goods and/or services) available from a merchant 110 and a transaction may be initiated by the customer to purchase such items. The merchant 110 may use a point of sale (POS) system 112 means to conduct the transaction. The POS system 112 may include, for example, a POS terminal for displaying information related to the transaction and a POS reader device for reading and transferring information related to the financial payment system (“payment information”). The POS system 112 may be equipped with hardware and software for facilitating the transaction between the customer and the merchant 110. The POS system 112 is configured to communicate with the processor 102 of the computing system 100, which receives payment information transferred from the POS system 112. The transaction may optionally be facilitated by a payment network 108 (shown in broken lines) or other intermediary before being conveyed to the computing system 100.

The customer may present the payment information to the merchant 110 in order to purchase the items from the merchant 110 and the POS system 112 may be used to read the payment information, such as a credit card number or the account identifier assigned to the customer upon registration. As a non-limiting example, the financial payment system may be a credit card or debit card, and the POS system 112 may include a card reader used by the merchant to record the sale and initiate approval of payment. The card may be read by the POS system 112 to initiate the transaction by the customer or the merchant passing or “swiping” the card through the reader. As another non-limiting example, the account identifier assigned to the customer's account during registration may be read using the POS system 112. The identifier may be stored and presented by the customer on a mobile device 114, as will be described in further detail. As yet another non-limiting example, the financial payment system may be an NFC tag.

The database 104 may store information related to the customer account (“account information”) and information related to the merchant 110 (“merchant information”), as well as information related to the offer provided by the merchant 110 (“offer information”). Such information may be stored in any number of ways known in the art, such as, by a code, a number, an image, etc. For example, the account information may include identifying information for the customer (e.g., name, address, zip code, email address, phone number, etc.) and identifying information for the financial payment system linked to the customer account (e.g., credit card number, debit card number, reward card number, an NFC tag, etc.). In some embodiments, the account information may be stored on the database 104 by the customer during the registration process using a communication device, such as the mobile device 114 (e.g., a mobile phone or tablet device). After completion of the registration process, a software application 116 may be provided to the customer that enables the computing system 100 to identify the customer and to communicate with the customer through the mobile device 114. The software application 116 may be downloaded onto the mobile device 114 after completion of the registration process by the customer. The software application 116, once downloaded onto the mobile device 114, enables communication between the mobile device 114 and the computing system 100. When the customer accesses the software application 116 on the mobile device 114, the computing system 100 may present offers provided by one or more merchants to the customer through the software application 116, which displays information related to the offer and the merchant to the customer on the mobile device 114.

The merchant information may be, for example, a merchant classification number such as a Standard Industry Classification code or other identifying information unique to the merchant 110. The merchant 110 may define the offer information, which is then stored on the database 104. The offer may include an incentive, such as a rebate, discount, coupon or other type of incentive. The offer information defined by the merchant 110 may specify, for example, products to which the offer applies, the incentive (e.g., refund or discount) that will be provided to the customer and any conditions for the customer's acceptance of the offer.

A web-based application or tool 111 may be provided to the merchant 110 that links the merchant 110 to the computing system 100 via the internet. The web-based tool 111 may be used by the merchant 110 to specify or define the offer information and store the offer information on the database 104. As non-limiting examples, the offer defined by the merchant 110 may be a percentage discount off a purchase price or discount for a particular dollar amount. In addition, the merchant 110 may define limitations on the offer, such as a limiting the offer to a certain number of customers, a particular period of time, particular days, first time customers or repeat customers. The web-based tool 111 may be linked to the computing system 100 via the communications module 106 such that the offer specified by the merchant 110 is stored on the database 104 where it may be accessed by the processor 102.

The computing system 100 may be configured for receiving information related to the purchase from the merchant 110. For example, the payment information (e.g., the credit card number or the customer's account identifier) may be transmitted to the computing system 100 by the POS system 112 as a purchase is made by the customer. The processor 102 may then process such information in order to correlate the payment information with account information stored on the database 104 to determine if the customer is a registered customer. Details related to the transaction, such as the product, price, date, store, SKU (stock-keeping unit), etc. may also be received by the computing system 100 from the POS system 112. If the financial payment system is a credit card, debit card or gift card, the computing system 100 may optionally transmit a request for payment to an issuer 118 of the financial payment system, such as an issuing bank or credit union. For example, the processor 102 of the computing system 100 may be configured to receive the request for payment from the merchant 110 via the POS system 112. The issuer 118 responds to the request by accepting or declining payment based on predetermined criteria, such as availability of funds, and conveys this request to the processor 102.

The processor 102 may also be configured to receive the merchant information, which is transmitted to the processor 102 by the POS system 112 during the transaction. The processor 102 may then correlate such merchant information with information stored on the database 104 in order to determine if the particular merchant 110 has defined an offer.

If the merchant 110 has specified an offer, the processor 102 may then determine if the customer qualifies for the offer. The processor 102 may then generate a notification including information related to the offer provided by the merchant 110. The notification may be transmitted (e.g., “pushed”) to the customer via the software application 116 on the customer's mobile device 114. The computing system 100 may utilize the communication module 106 to push the notification to the mobile device 114 using the software application 116. Since the computing system 100 receives the account information and merchant information while the transaction is processed at the POS system 112, the computing system 100 may determine if the customer qualifies for the offer and will push the notification to the mobile device 114 during the transaction or before the transaction is complete.

The notification pushed to the mobile device 114 by the computing system 100 may include details related to the offer. For example, the offer may include at least one incentive, such as a rebate, a discount or other incentive. Optionally, the offer may also include at least one condition that must be satisfied by the customer in order to receive the offer. As a non-limiting example, the merchant 110 may define the offer to be contingent on the customer accessing at least one social network 120 and providing at least one electronic message, or a so-called “post,” on the social network 120 including details specified by the merchant 110. Examples of social networks 120 include, but are not limited to, Facebook®, Twitter®, Friendster®, Yelp®, MySpace®, Bebo®, Flickr® and Google+™. The electronic message posted by the customer may include, for example, text, links, images, videos, communications, opinions, software, data, or other content. For example, the software application 116 may be linked to the social network 120 and may enable the user to post the electronic message. As another non-limiting example, the merchant 110 may request that the customer provide particular information about the purchase or the products and/or services received, such as the type of product and/or service or a rating. Such information may be posted on the social network 120 or, alternatively, may be sent directly to the merchant 110 by the customer.

A “social network” can be a social structure made up of individuals (or organizations), which are tied (connected) by one or more specific types of interdependency, such as friendship, kinship, common interest, financial exchange, dislike, sexual relationships, or relationships of beliefs, knowledge or prestige.

Facebook, for example, is a social networking service and Web site launched in February 2004. Users must register before using the site, after which they may create a personal profile, add other users such as friends, and exchange messages, including automatic notifications when they update their profile. Additionally, users may join common-interest user groups, organized by workplace, school or college, or other characteristics, and categorize their friends into lists such as “People From Work” or “Close Friends”. Users can create profiles with photos, lists of personal interests, contact information, and other personal information. Users can communicate with friends and other users through private or public messages and a chat feature. They can also create and join interest groups and “like pages” (called “fan pages” until Apr. 19, 2010), some of which are maintained by organizations as a means of advertising.

MySpace allows users to decorate their profiles using HTML and Cascading Style Sheets (CSS), while Facebook allows only plain text. Facebook has a number of features with which users may interact. They include the Wall, a space on every user's profile page that allows friends to post messages for the user to see; Pokes, which allows users to send a virtual “poke” to each other (a notification then tells a user that they have been poked); Photos, where users can upload albums and photos; and Status, which allows users to inform their friends of their whereabouts and actions. Depending on privacy settings, anyone who can see a user's profile can also view that user's Wall. In July 2007, Facebook began allowing users to post attachments to the Wall, whereas the Wall was previously limited to textual content only.

Twitter® is an online social networking and microblogging service that enables its users to send and read text-based posts of up to 140 characters, informally known as “tweets”. Twitter has been compared to a web-based Internet Relay Chat (IRC) client. Tweets are publicly visible by default; however, senders can restrict message delivery to just their followers. Users can tweet via the Twitter website, compatible external applications (such as for smartphones), or by Short Message Service (SMS) available in certain countries. Users may subscribe to other users' tweets, this is known as “following” and subscribers are known as followers or tweeps (Twitter+peeps). Twitter allows users the ability to update their profile by using their mobile phone either by text messaging or by apps released for certain smartphones/tablets. As a social network, Twitter revolves around the principle of followers. When you choose to follow another Twitter user, that user's tweets appear in reverse chronological order on your main Twitter page.

The processor 102 may be configured to provide the incentive specified in the offer to the customer. For example, if the financial payment system used to make the transaction is a credit card, the merchant 110 may charge the full purchase price to the customer's credit card and the processor 102 may be used to provide a refund to the credit card in the amount specified in the offer.

In some embodiments, the offer may be presented to the customer prior to purchase of an item from the merchant 110. For example, the computing system 100, via the processor 102, may use at least one indicator (e.g., location, past purchases, etc.) to determine offers that may be relevant to a customer, such as offers being made by merchants within a certain distance of the customer's location or offers being made by merchants frequently visited by the customer.

In other embodiments, the customer may be unaware of the offer until the transaction is initiated at the POS system 112. In such an embodiment, the customer may make a purchase from the merchant 110 that qualifies for the offer. The POS system 112 transmits information related to the transaction, including the customer identifier and the merchant identifier, to the computing system 100 where the processor 102 matches the information against transaction against the software.

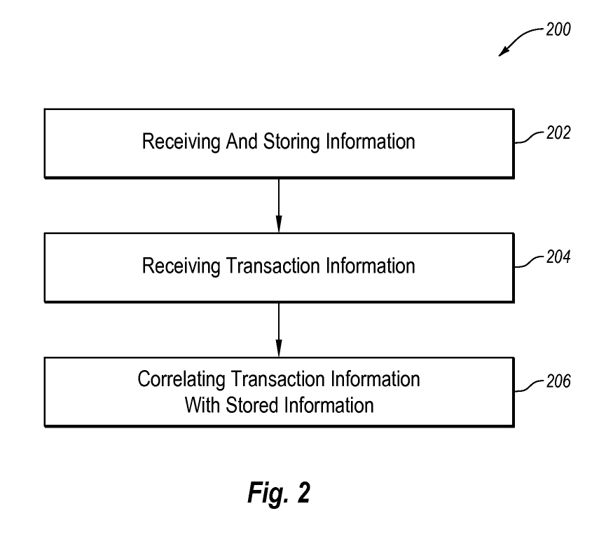

FIG. 2 is a flow diagram illustrating an embodiment of a method 200 of correlating a customer with a particular financial payment system. The method 200 may be performed, for example, using a computing system 100 such as that described with respect FIG. 1, the computing system including a processor 102 and a database 104 for storing information accessible by the processor 102. The computing system 100 may include one or more computer-readable media having computer-executable instructions, that when executed, implement the method 200.

As shown in FIG. 2, the method 200 includes receiving and storing customer account information 202. As previously discussed, the account information includes information relating to at least one financial payment system, such as an account number for a credit card. The account information may also include a customer's name, physical address or zip code, email address, phone number, age, etc. The account information may be received using the processor 102 (FIG. 1) and may be stored on the database 104 (FIG. 1). After the account information is received, the customer may optionally be provided with a software application configured for download onto a mobile device. The software application may enable communication with the customer. In some embodiments, the customer may be provided with a unique account identifier that links the financial payment system to the customer account. The account identifier may be stored, for example, via the software application on the customer's mobile device which may be used to make purchases.

The method 200 may also include receiving information 204 related to a transaction between the customer and the merchant. The transaction may be initiated between the customer and a merchant and the payment information may be gathered, for example, using a POS system and transmitted to the processor 102 (FIG. 1). For example, the customer may use a credit card as the financial payment system for the transaction and the credit card number may be transmitted to and received by the system. As another example, the customer may use the account identifier to make the purchase and the account identifier may be transmitted to and received by the system.

The payment information may then be compared to information stored on the database 104 (FIG. 1) to determine if the financial payment system is associated or correlates with a registered customer 206.

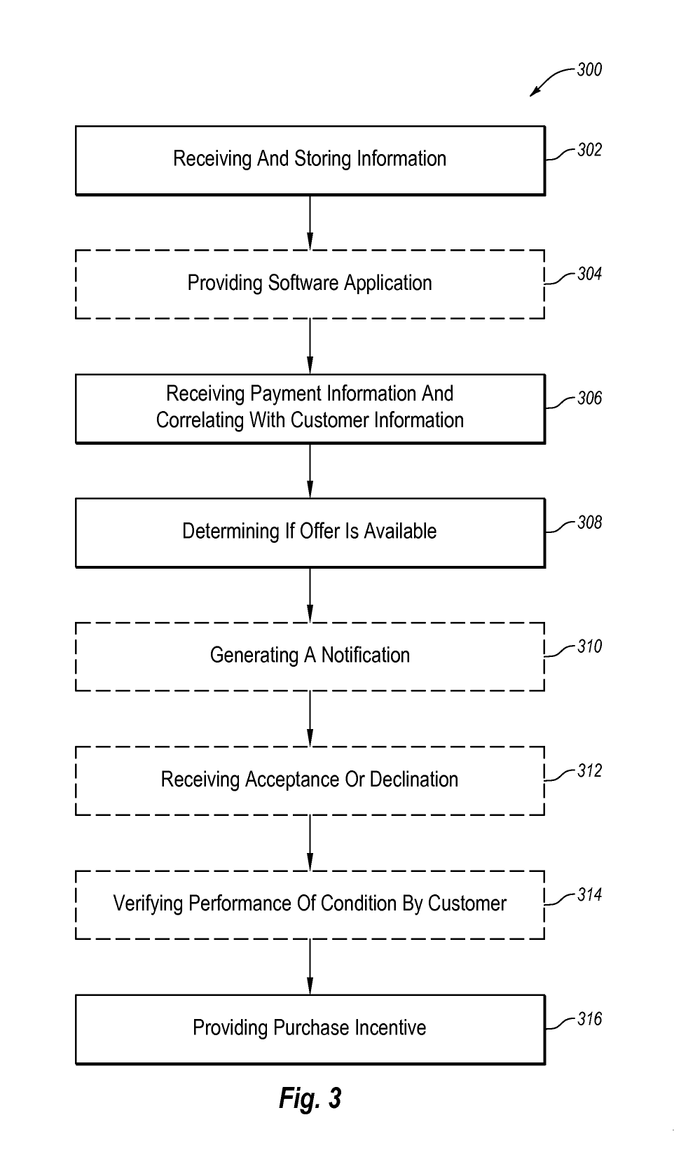

FIG. 3 is a flow diagram illustrating a method 300 of offering an incentive based on at least one financial payment system. The method 300 may be performed, for example, using a computing system 100 such as that described with respect FIG. 1, the computing system including a processor 102 and a database 104 for storing information accessible by the processor 102. The computing system 100 may include one or more computer-readable media having computer-executable instructions, that when executed, implement the method 300.

As shown in FIG. 3, the method 300 may include receiving and storing account information and merchant information 302. The account information may include identifying information for the registered customer and identifying information for the financial payment system linked to the registered customer's account. The merchant information includes at least one offer, e.g., a rebate, a discount or another incentive, that applies to one or more products sold by the merchant, or to an entire purchase.

In some embodiments, the method 300 may optionally include providing a software application 304 (shown in broken lines) to the registered customer, the software application configured for being downloaded onto a mobile device accessible by the registered customer. Information for communicating with the mobile device may be stored with the registered customer's account information. The software application may, thus, facilitate communication with the registered customer enabling registered customer to receive electronic notifications or messages.

The method 300 also includes receiving payment information from a merchant and determining if the financial payment system correlates with account information for the registered customer 306. The registered customer may present the financial payment system to the merchant during a transaction and the merchant may transmit financial payment system information (e.g., an account number for a credit card). Upon receiving the financial payment system information from the merchant, the financial payment system information may be correlated with information stored on the database to determine if the financial payment system used in the transaction corresponds to a registered customer. The determination may be made using the processor 102 (FIG. 1), which correlates the information related to the financial payment system received from the merchant to stored information on the database 104 (FIG. 2). The financial payment system may be a credit card and a payment request may be sent to an issuer the financial payment system. Thus, the method 300 may be automated using an established payment network.

The method 300 may also include determining if an offer is available 308 from the merchant. The merchant information may be received and may include information related to the purchase made by the registered customer. If it is determined that the registered customer qualifies for an offer, information may be correlated with stored merchant information and a notification may be generated 310. The notification may be pushed to the registered customer via the software application installed on the registered customer's mobile device. The notification may be immediately transmitted to the registered customer during the transaction. For example, if the financial payment system is a credit card, the registered customer may receive the notification before or during approval of the credit card. The notification may inform the registered customer that their purchase qualifies for the offer and may enable the registered customer to choose whether they want to take advantage of the offer. The notification may be, for example, an electronic message including information related to an offer. Optionally, the notification may include a feature that prompts the registered customer to accept or decline the offer and the acceptance or declination of the offer may be received 312 (as shown in broken lines).

For example, the notification may include information related to an incentive being offered by the merchant. The notification may also include a condition that must be satisfied by the registered customer before the incentive will be provided. In embodiments in which the offer includes the condition, performance of by the registered customer may be verified 314 (as shown in broken lines). For example, the offer may be contingent on the registered customer posting an electronic message defined by the merchant on at least one social network. As a non-limiting example, the registered customer may post the electronic message, as specified by the merchant, on the social network, and performance of the condition may be verified. As another non-limiting example, the software application installed on the mobile phone may be linked to the social network, and the registered customer may post the electronic message via the software application. The software application, which communicates with the processor 102 (FIG. 1), may automatically send verification of the registered customer's fulfillment of the obligation.

A mobile phone (also known as a cellular phone, cell phone and a hand phone) can include a mobile device which can make and receive telephone calls over a radio link whilst moving around a wide geographic area. It can also do so by connecting to a cellular network provided by a mobile network operator. The calls can be to and from the public telephone network which includes other mobiles devices and fixed-line phones across the world. In addition to telephony, modern mobile phones can also support a wide variety of other services such as text messaging, MMS, email, Internet access, short-range wireless communications (infrared, Bluetooth), business applications, gaming and photography. Mobile phones that offer these and more general computing capabilities can be referred to as smartphones.

A tablet device or tablet PC can include a small, thin, flat tablet-sized computer that has many key features of a full-size personal computer. A tablet PC is essentially a small laptop computer without a keyboard, equipped with a touchscreen as an input device which is used as a virtual keyboard on touch screen smartphones, and running an adapted PC operating system such as Microsoft Windows, or an adapted desktop version of Linux.

The incentive associated with the offer may then be provided 316 to the registered customer. For example, the registered customer may be charged the full purchase price by the merchant at the time of transaction and a refund a refund equal to the incentive associated with the offer may be provided to the financial payment system (e.g., credit card) linked to the registered customer through the account.

Embodiments herein may comprise a special purpose or general purpose computer including various computer hardware. Embodiments may also include tangible computer-readable media for carrying or having computer-executable instructions or data structures stored thereon. Such tangible computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

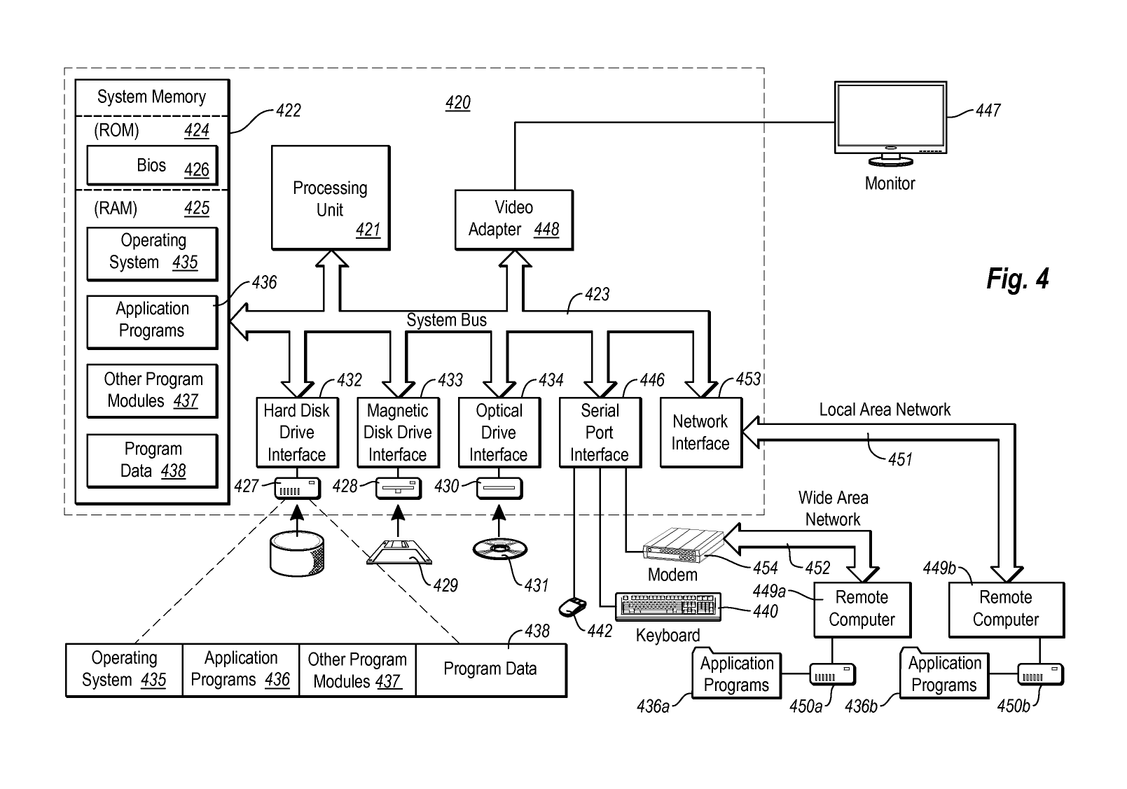

With reference to FIG. 4, an example of a processing system for implementing at least portions of the technology herein includes a general purpose computing device in the form of a computer 420. Components of computer 420 may include, but are not limited to, a processing unit 421, a system memory 422, and a system bus 423 that couples various system components including the system memory to the processing unit 421. The system bus 423 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Processing means, such as computer means 420 or the processor of mobile phone, tablet PC, or other processing device typically includes a variety of computer readable media. Computer readable media can be any available media that can be accessed by computer 420 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Referring again to FIG. 4, the system memory 422 includes computer storage media in the form of volatile and/or nonvolatile memory such as read only memory (ROM) 424 and random access memory (RAM) 425. A basic input/output system 426 (BIOS), containing the basic routines that help to transfer information between elements within computer 420, such as during start-up, is typically stored in ROM 424. RAM 425 typically contains data and/or program modules that are immediately accessible to and/or presently being operated on by processing unit 421. By way of example, and not limitation, FIG. 4 illustrates operating system 435, application programs 436, other program modules 437, and program data 438.

The computer 420 may also include other removable/non-removable, volatile/nonvolatile computer storage media. By way of example only, FIG. 4 illustrates a hard disk drive 432 that reads from or writes to non-removable, nonvolatile magnetic media, a magnetic disk drive 433 that reads from or writes to a removable, nonvolatile magnetic disk 429, and an optical disk drive 434 that reads from or writes to a removable, nonvolatile optical disk 431 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 4, provide storage of computer readable instructions, data structures, program modules and other data for the computer 420. In FIG. 4, for example, hard disk drive 432 is illustrated as storing operating system 435, application programs 436, other program modules 437, and program data 438. Note that these components can either be the same as or different from operating system 435, application programs 436, other program modules 437, and program data 438. Operating system 435, application programs 436, other program modules 437, and program data 438 are given different numbers here to illustrate that, at a minimum, they are different copies. A user may enter commands and information into the computer 420 through input devices such as a keyboard 440 and pointing device 442, commonly referred to as a mouse, trackball or touch pad. Other input devices (not shown) may include a microphone, joystick, game pad, satellite dish, scanner, or the like. These and other input devices are often connected to the processing unit 421 through a user input interface 446 that is coupled to the system bus, but may be connected by other interface and bus structures, such as a parallel port, game port or a universal serial bus (USB). A monitor 447 or other type of display device is also connected to the system bus 423 via an interface, such as a video interface 448. In addition to the monitor 447, computers may also include other peripheral output devices such as speakers and printer, which may be connected through an output peripheral interface.

The computer 420 may operate in a networked environment using logical connections to one or more remote computers, such as remote computers 449a and 449b. The remote computers 449a and 449b may be a personal computer, a server, a router, a network PC, a peer device or other common network node, and typically includes many or all of the elements described above relative to the computer 420, although only memory storage devices 450a and 450b have been illustrated in FIG. 4. The logical connections depicted in FIG. 4 include a local area network (LAN) 451 and a wide area network (WAN) 452, but may also include other networks. Such networking environments are commonplace in offices, enterprise-wide computer networks, intranets and the Internet.

When used in a LAN networking environment, the computer 420 is connected to the LAN 452 through a network interface or adapter 446. When used in a WAN networking environment, the computer 420 typically includes a modem 454 or other means for establishing communications over the WAN 452, such as the Internet. The modem 454, which may be internal or external, may be connected to the system bus 423 via the user input interface 446, or other appropriate mechanism. In a networked environment, program modules depicted relative to the computer 420, or portions thereof, may be stored in the remote memory storage device. By way of example, and not limitation, FIG. 4 illustrates remote application programs 436a and 436b as residing on memory device 450a and 450b. It will be appreciated that the network connections shown are exemplary and other means of establishing a communications link between the computers may be used.

Explanation of the Internet, computers, and networks can also be understood by reading “How the Internet Works” seventh ed. by Preston Gralla (2004) Que Publishing, “How Networks Work”, seventh ed. by Frank Derfler Jr. and Les Freed (2005) Que Publishing, and “How Computers Work” seventh ed. by Ron White (2004) Que Publishing, the contents of all three books are hereby incorporated by reference herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a payment processor within a computing system including the payment processor and an issuer of a financial payment system, a method of linking a financial payment system to a customer account, comprising:
receiving a payment request from a merchant including a merchant identifier and a customer account identifier for identifying the financial payment system;
associating the financial payment system with a registered customer by comparing the customer account identifier with customer account information for the registered customer maintained at the payment processor; and
communicating with the issuer of the financial payment system to request authorization to grant the payment request.

2. The method of claim 1, wherein receiving the payment request from the merchant including the merchant identifier and the customer account identifier includes receiving an account number for a credit card or debit card.

3. The method of claim 1, further comprising:
receiving and storing customer account information for the registered customer, the customer account information including the customer account identifier and information enabling access to a mobile device accessible by the registered customer; and
providing a software application to the registered customer, the software application configured for being downloaded onto the mobile device and, once downloaded onto the mobile device, enabling communication between the payment processor and the registered customer via the mobile device.

4. The method of claim 1, further comprising generating an electronic notification including information related to at least one offer being provided by the merchant, the offer including an incentive to be provided to the registered customer upon purchase of a specified item from the merchant.

5. The method of claim 4, further comprising providing the incentive directly to the financial payment system linked to the customer account in the form of a refund.

6. The method of claim 4, further comprising transmitting the electronic notification to the registered customer for displaying the notification on a mobile device accessible by the customer using a software application configured for enabling communication between the payment processor and the registered customer.

7. The method of claim 4, wherein generating an electronic notification with a message from the merchant to the customer includes generating the electronic notification including at least one condition for accepting the incentive offered by the merchant.

8. The method of claim 7, further comprising verifying completion of the at least one condition for accepting an incentive and providing a rebate to the payment system.

9. The method of claim 1, wherein associating the financial payment system with a registered customer by comparing the customer account identifier with customer account information for the registered customer maintained at the payment processor includes:
correlating a unique account identifier assigned to the customer account with the customer account information associated with the unique customer identifier, the customer account information stored in a location accessible by the processor;
correlating the merchant identifier with stored information accessible by the processor to determine if a purchase associated with the payment request qualifies for an offer including at least one incentive related to the payment request;
transmitting an electronic message generated by the payment processor to the registered customer, the electronic message including a prompt requesting that the registered customer confirm acceptance of the offer; and
providing the at least one incentive to the registered customer by refunding a predetermined amount of a purchase price related to the payment request.

10. A tangible computer-readable media for carrying or having computer-executable instructions or data structures stored thereon for performing the method of claim 1 when executed by a processing device.

11. In a computing system including a processor and a database for storing information, a method of linking a financial payment system to a customer account, comprising:
receiving transaction information relating to a transaction between a merchant and a customer using a processor, the transaction information including an identifier for the financial payment system used by the customer;
correlating the identifier with data relating to the customer account stored on the database using the processor to determine if the customer qualifies for an incentive provided by the merchant;
generating an electronic message including information related to the incentive using the processor and transmitting the electronic message to the customer via a software application in communication with the processor; and
providing the incentive to the customer.

12. The method of claim 11, further comprising receiving and storing information related to the customer on the database to generate the customer account, the information including the identifier for the financial payment system.

13. The method of claim 11, wherein receiving transaction information relating to the transaction between the merchant and the customer using the processor includes receiving an account number for a credit card, an account number for a debit card, a number associated with a reward card or a number associated with a near field communication card.

14. The method of claim 11, wherein receiving transaction information relating to the transaction between the merchant and the customer using the processor includes receiving information related to the merchant such that the processor may identify the merchant.

15. The method of claim 11, wherein generating an electronic message including information related to the incentive includes generating the electronic message to include a prompt requesting that the customer accept the incentive.

16. The method of claim 11, wherein transmitting the electronic message to the customer via a software application in communication with the processor includes transmitting the electronic message to the customer via the software application on a mobile device, contact information for the mobile device being accessed by the processor through the customer account.

17. The method of claim 11, further comprising providing the software application as an interface between the customer and the processor, the software application enabling display of the electronic message on a mobile device accessible by the user.

18. The method of claim 11, further comprising providing a web-based tool as an interface between the merchant and the processor, the web-based tool enabling the merchant to define the incentive.

19. The method of claim 11, wherein providing the incentive to the customer includes directly refunding a credit card used as the financial payment system.

20. The method of claim 11, wherein generating an electronic message comprising information related to the incentive using the processor includes generating the electronic message further including a condition for acceptance of the incentive, the condition specifying that the incentive will be provided contingent on the customer accessing at least one social network to broadcast a predetermined message after completion of the transaction between the merchant and the customer.

21. The method of claim 20, further comprising verifying performance of the condition by the customer using the processor before providing the incentive to the customer.

22. A tangible computer-readable media for carrying or having computer-executable instructions or data structures stored thereon for performing the method of claim 11.
